(19) United States
(12) Patent Application Publication
(10) Pub. No.: US 2013/0187534 A1
(43) Pub. Date: Jul. 25, 2013

(54) PHOSPHORIZED KERNELS FOR REMOTE PHOSPHOR LED

(71) Applicant: David Gershaw, Danvers, MA (US)

(72) Inventor: David Gershaw, Danvers, MA (US)

(73) Assignee: Remphos Technologies LLC, Danvers, MA (US)

(21) Appl. No.: 13/355,142

(22) Filed: Jan. 20, 2012

(51) Int. Cl. H01J 1/62; B29C 45/00; C09K 11/08

(52) U.S. Cl. 313/498; 252/301.4 R; 252/301.36; 264/104

(57) ABSTRACT

Compositions, methods, and systems for improving ways by which light can be created are provided. In one exemplary embodiment, a composition can be formed by mixing a particular amount of a carrier and a particular amount of one or more phosphors. The carrier can be selected from a group including plastic materials, glass materials, and ceramic materials. The resulting mixture can be formed into pellets or kernels for use with a LED die. The pellets or kernels can be used in place of powders or other coatings typically used with LED packages. Methods for manufacturing the pellets or kernels, and for creating light by using the pellets or kernels, are also provided.

### FIELD

The present disclosure relates to improving LED lighting systems that produce light visible to the human eye. Those skilled in the art will appreciate the applicability of the present application to a variety of applications such as general purpose, decretive, ornamental, special effects, automotive lighting, and other applications.

### BACKGROUND

Typically, a white LED package includes an LED die that emits blue light covered by a phosphor coating. The phosphor can assist in converting a portion of blue light radiation into white light.

There are many examples of phosphors, but typically phosphors can be yellow, orange, red, and green. An example of a commonly used phosphor is the yellow emitting yttrium gadolinium aluminum garnet (YAG) phosphor, which can be activated with Ce3+. Other types and colors of phosphors can also be used to convert ultra violet (UV) emitting chips into white visible light. Although the present invention is primarily directed to compositions, methods, and systems used in conjunction with blue LED dies, the methods, compositions, and systems disclosed herein can be used in conjunction with other LEDs, such as UV LEDs.

One or more yellow, green, orange and red phosphors can be blended to produce a white light targeting a certain chromaticity, correlated color temperature (CCT), and/or color rendering index (CRI). The resulting blend is typically coated in a uniform manner on top of the chip. In order to apply and permanently affix the resulting blend, which is often a phosphor powder, on the chip, the phosphor powder is encapsulated before applying it to the chip.

One method typically used to encapsulate the phosphor powder is to mix the phosphor powder with a liquid medium such as silicone or epoxy. The phosphor blend can be mixed with the liquid medium and then dispensed on top of the chip, for instance, by using a syringe, screen printing, a spray or an electroplating process. This method is commonly referred to as die level conversion.

In die level conversion, a very uniform application of the phosphor powder is typically required on top of the chip. If an incorrect blend of phosphor/liquid medium and or a non-uniform or incorrect thickness of the blend is applied to, for example, a blue LED die, it can result in an incorrect white light that does not meet the targeted chromaticity, CCT and/or CRI.

Additional methods have been proposed to overcome the difficulty in traditional die level conversion methods. One of these methods is remote phosphor. Remote phosphor technology can be defined as a process in which the phosphor is placed at a remote level above the LED die. Remote phosphor can be carried out with either liquid or solid phosphor carriers. The liquid method is done by creating three dimensional forms of liquid carriers (e.g., silicone or epoxy) that are injection molded (in the shape of, for example, domes) and then placed on top of the LED die.

In solid carrier remote phosphor technology, a solid carrier replaces the liquid carrier of the phosphor. These carriers can include a glass, ceramic or a plastic material. Once the phosphor has been combined with these materials, precise thickness sheets or three-dimensional forms can be created in a number of different manners, including by extrusion, injection molding, blow molding, and thermo-formation. The sheets and three-dimensional forms can take a variety of different shapes, including, by way of non-limiting example, hemispherical shapes, ovular shapes, ellipsoids of revolution, and paraboloids. These sheets or three-dimensional forms can be of virtually any shape and size. Single or multiple LED die or LED packages can be placed under the remote phosphor and the blue light can be excited by this remote level of phosphor, as opposed to the phosphor on chip method. Phosphor cannot be combined with these carriers by mechanisms similar to the ones described above with respect to the liquid method. These glass or polymeric materials bring new challenges in order to combine the phosphor with them successfully, at least because they are solids and not liquids at ambient temperature.

Whether the process chosen to make the white LED light is traditional phosphor on chip or the remote phosphor method, great care should generally be taken before the phosphor is mixed with its carrier to store it in a controlled environment including keeping it in dry boxes to ensure that exposure to humidity and sources of contamination is minimized.

In traditional die level conversion of mixing the phosphor with a liquid carrier, the silicone or epoxy is typically cured once it is applied to the chip. The curing of the liquid carrier can generally only be carried out once, and therefore once it is has been applied to the die, it generally cannot be removed or reused. This can lead to wasted materials.

However, in the remote phosphor solid carrier method, the glass, ceramic or plastic material typically has no curing agent and therefore can be reused.

During the die level conversion and remote phosphor liquid or solid carrier methods, problems exist in manufacturing a repeatable white LED package. For example, there can be difficulty in storing the phosphors. It can require great skill to find the precise ratios of the one or more phosphors. Phosphors settle at different rates inside of the liquid, glass, ceramic or plastic carriers. Still further, it can be quite difficult to homogeneously combine phosphor with solid liquid, glass, ceramic or plastic carriers.

The present application contemplates new and improved compositions, methods, and systems that overcome the above-referenced problems and others.

### SUMMARY

The present invention involves mixing one or more phosphors at precise ratios and compounding the phosphor(s) into carriers that include glass, plastic, or ceramic materials. The materials that result from the mixing and/or compounding process can then be made into plastic or glass or ceramic pellets or kernels carrying the phosphor inside. These phosphorized plastic or glass or ceramic kernels can then be supplied to any LED manufacturer or LED lamp manufacturer. The resulting kernels can be stored easily and then used at any time to make parts of desired shapes and dimensions. These kernels can be incorporated into a plastic part that can be positioned above the LED die, for instance using a remote phosphor method, to assist in the creation of white light. Alternatively, one or more phosphors can be mixed at precise ratios with carriers that include glass, plastic, or ceramic materials, and the resulting mixture can be fed directly into a downstream molding machine to be formed into a final part, such as a LED lamp. By way of non-limiting example, the molding machine can be a sheet, profile, or injection molding machine, and the mixture can be formed into a final part without first being compounded into a pellet or kernel.

There is great flexibility to the manufacturer of an LED lamp that is using the above- described three-dimensional formed parts (formed by way of, for example injection molding, extrusion, or other processes) if the manufacturer receives the phosphor in kernel form as opposed to in the powder form. These phosphor plastic, glass or ceramic kernels can be easily stored in bags, jars, buckets or in any number of other manners. No extreme special care needs to be taken to store the kernels. Once the manufacturer is ready to use the kernels, they can be molded into flat disks or three dimensional shapes, such as domes, or more complicated shapes. They can also be extruded into sheet or profile form and used in that form or thermoformed into different shapes. They can also be blow molded into a desired shape. There are additional methods not mentioned herein for which the kernels can be utilized to create a layer of phosphor for white light creation.

In embodiments in which the final part is created without first compounding the mixture of phosphors and carriers, benefits can include that the part is formed in a single step, the amount o thermal cycling can be reduced, and the likelihood of damaging any optical properties of the resulting part can be reduced.

To create plastic phosphor kernels, the base material for the kernel can be an optical grade plastic such as polypropylene, polycarbonate, acrylic, cyclic olefin polymers and copolymers or others depending on the intended use.

To create glass phosphor kernels, the base material could be any form of glass depending on the intended use. To create ceramic phosphor kernels, the base material can be any form of ceramic depending, at least in part, on the intended use.

The phosphorized plastic or glass or ceramic kernels can have a yellow appearance in order to create “cool white” (CCT: ˜5000-7000K), an orange appearance to create “warm light” (CCT: ˜2000-5000K), or a green appearance when used in conjunction with red light emitting LED die. A person having skill in the art will recognize other ways by which other colors can be produced.

The phosphorized plastic or glass or ceramic kernels can be provided to a LED manufacturer or LED lamp manufacturer along with an accompanying data table that indicates, for example, the thickness of the final part to be made, the required wavelength of LED light excitation, and/or the processing conditions for the manufacturing process (e.g., blow molding, injection molding, extrusion, thermo-formation, etc.), in order to target a particular chromaticity, CCT and/or CRI. Some examples of such tables are provided in FIGS. 10A-10C, which are discussed in further detail below.

Providing the phosphor in this kernel form and the data table makes it simple for a manufacturer, whether skilled or not skilled in the art of LED manufacturing, to be able to easily produce an efficient white LED light source.

While there are many methods by which the present teachings can be practiced, one mode of carrying out the present teachings is provided herein and includes some variations and modifications for various embodiments. No preference has been taken to the selection of choosing to describe this mode. A person skilled in the art would be able to come up with additional modes for carrying out this invention in view of the present disclosure.

In accordance with one mode of carrying out this invention, a method of manufacturing a phosphorized plastic pellets is disclosed. A phosphor or phosphors can be chosen. A plastic resin can also be chosen. The plastic resin can then either be left in its pellet form or it can be pulverized to reduce the size of the resin particles. One or more phosphors, in whichever form, can be mixed at precise ratios. The phosphor powders can be mixed with the resin pellets or powders. The phosphor and plastic mix can then be inserted into a compounding extruder. The compounding extruder can heat the materials, melting the plastic resin while it mixes the powder into it as the mix is driven forward. Once the plastic and powder has been completely integrated together, it can be pushed through a die. A strand of phosphorized plastic can be pulled from a die coupled to the extruder and can be pelletized into kernels, for instance, by using knives that chop the strand into pieces. The phosphorized kernels can then be stored for future processing into finished components.

In another embodiment of the invention, a composition to assist in formation of light can include a mixture. The mixture can include a particular amount of a carrier and a particular amount of one or more phosphors. The carrier can be selected from a group that includes one or more plastic materials, one or more glass materials, and one or more ceramic materials. In some embodiments, the particular amount of the carrier can be pulverized. In some embodiments, at least one of the one or more phosphors can be in powder form. The mixture can be homogeneous. The composition can include one or more kernels, with each kernel including the mixture. In some embodiments, the particular amount of the carrier and the particular amount of the one or more phosphors can be expressed in a ratio. By way of non-limiting example, a ratio of the particular amount of the carrier to the particular amount of the one or more phosphors can be approximately in the range of about 2 percent to about 20 percent.

A system to assist in formation of light can include a composition having a mixture and one or more data tables having data related to properties of the composition. The mixture can include a particular amount of a carrier and a particular amount of one or more phosphors. The carrier can be selected from a group that includes one or more plastic materials, one or more glass materials, and one or more ceramic materials. The data can inform the particular amount of the carrier and the particular amount of the one or more phosphors to be used in the mixture. The data of the one or more tables can include data related to a number of properties, including but not limited to a thickness of a device with which the composition will be used, a wavelength of LED light excitation, and a process by which the mixture is to be formed. Some examples of processes by which the mixture can be formed include extrusion, injection molding, and blow molding. The data can also be related to a number of properties, such properties of a resulting kernel. By way of non-limiting example, these properties include a chromaticity of a resulting kernel, a correlated color temperature (CCT) of a resulting kernel, and a color rendering index (CRI) of a resulting kernel.

A method of creating white light can include positioning a composition having a mixture proximal to a LED die of a light source and securing the composition such that it is substantially fixed. The mixture can include a particular amount of a carrier and a particular amount of one or more phosphors. The carrier can be selected from a group that includes one or more plastic materials, one or more glass materials, and one or more ceramic materials.

A method of manufacturing a composition to assist in formation of light can include mixing a carrier and one or more phosphors to form a mixture, inserting the mixture into an extruding device, processing and heating the mixture using the extruding device to produce one or more strands of mixture, and forming kernels from the one or more strands of mixture. The method can further include pulverizing the carrier prior to mixing the carrier with the one or more phosphors. Mixing a carrier and one or more phosphors can also include mixing a particular ratio of carrier to one or more phosphors. In some embodiments, the ratio can be in the range of about 2 percent to about 20 percent.

A method of manufacturing a LED lamp can include mixing a carrier and one or more phosphors to form a mixture, feeding the mixture into a molding machine, and operating the molding machine to form a LED lamp. The LED lamp can include the mixture. Mixing a carrier and one or more phosphors can also include mixing a particular ratio of carrier to one or more phosphors. In some embodiments, the ratio can be in the range of about 2 percent to about 20 percent.

The advantages of the present application reside, at least in part, in an improved method for providing the phosphor to LED manufacturers or LED lamp manufacturers to assist the manufacturers in creating white light.

### BRIEF DESCRIPTION OF DRAWINGS

The application may take form in various components and arrangements of components, and in various steps and arrangements of steps. The drawings are only for purposes of illustrating the preferred embodiments and are not to be construed as limiting the application.

FIG. 1 is a transparent, side-view of one exemplary embodiment of a bottle holding phosphor powder;

FIG. 2 is a transparent, side-view of one exemplary embodiment of a bottle holding plastic resin pellets;

FIG. 3 is a transparent, side-view of one exemplary embodiment of a bottle holding pulverized plastic resin;

FIG. 4 is a transparent, side-view of one exemplary embodiment of a bottle holding pulverized plastic resin mixed with phosphor powder;

FIG. 5 is a transparent, side-view of one exemplary embodiment of a bottle holding plastic resin mixed with phosphor powder;

FIG. 6 is a schematic view of one exemplary embodiment of a device for executing an extrusion compounding process;

FIG. 7 is a transparent, side-view of one exemplary embodiment of a bottle holding phosphorized plastic kernels;

FIG. 8 is a chart of non-limiting examples of processing parameters for two different types of compound extruders in accordance with the teachings herein;

FIG. 9 is a graph of some example relationships between phosphor loaded in a carrier and resulting correlated color temperatures (CCT); and

FIGS. 10A-10C is a series of charts illustrating some types of information that can be used by a manufacturer of a finished remote phosphor component, such as a LED or lamp, in accordance with the teachings herein.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those having skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In one mode of carrying out this invention, a process for manufacturing a plastic phosphorized kernel is described as follows.

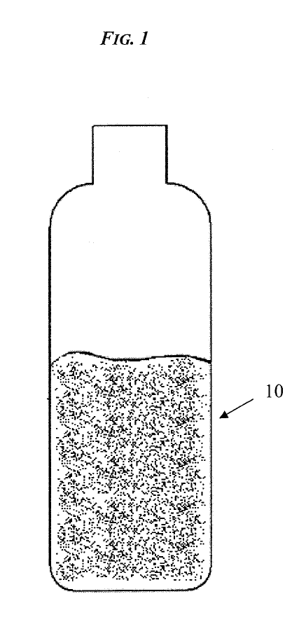

With reference to FIG. 1, an illustration of a bottle holding phosphor powder 10 is shown. The phosphor powder 10 can include one or more phosphors that have been mixed together to form the powder. Some examples of phosphor powder 10 can be found commercially from companies such as OSRAM, Intematix, Nichia etc. There are many different types of phosphors that can be utilized depending on factors such as performance and cost. The color and appearance of the phosphor powder 10 can vary depending on the end result desired to create different types of white light using varying wavelengths of LED die.

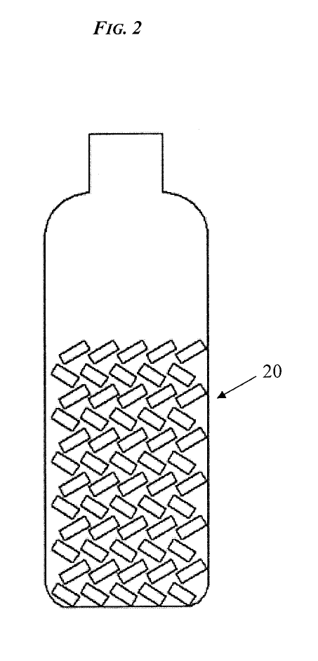

With reference to FIG. 2, an illustration of a bottle holding plastic resin 20 is shown. The plastic resin 20 can include one or more plastic resins, such as polypropylene, polycarbonate, acrylic, cyclic olefin polymers and copolymers, or others depending, at least in part, on the intended use. The plastic resins listed above are resins that are commercially available from companies such as Bayer, Sabic, Sunoco, etc. Plastic resins that have improved optical clarity can be favorable. Plastic resins can be chosen depending on factors such as performance and cost. The color and appearance of the plastic resin 10 can vary depending on the type of plastic resin selected.

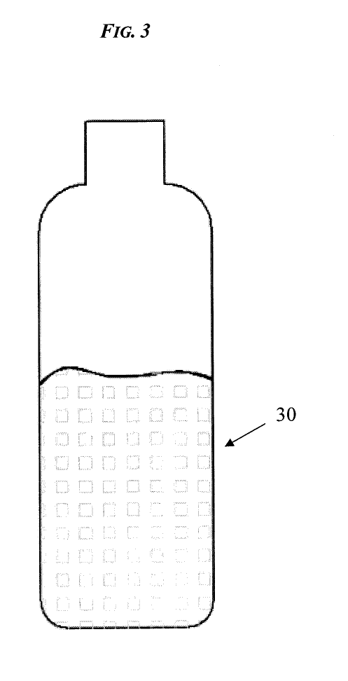

With reference to FIG. 3, an illustration of a bottle holding pulverized plastic resin 30 is shown. The plastic resin 20 described in FIG. 2 is taken and the particles can be reduced in size through a commercially available grinding or cutting method, such as plastic pulverization, cryogenic pulverization, jet air pulverization or other methods. The pulverization process can reduce the size of the plastic resin 20 to a particle size closer in size to the phosphor powder 10. This can be beneficial because the phosphor powder 10 can be sensitive to forces put on it during a compounding process that will be described in greater detail below. While the plastic resin 20 can be left in its original form, typically pulverizing the resin results in more consistent results. The color and appearance of the pulverized plastic resin 30 can vary depending, at least in part, on the type of plastic resin 20 that is utilized.

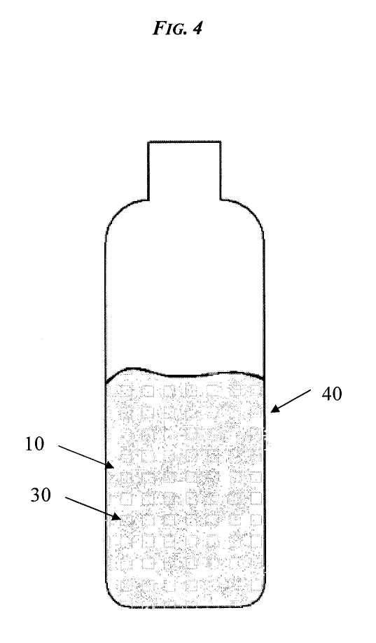

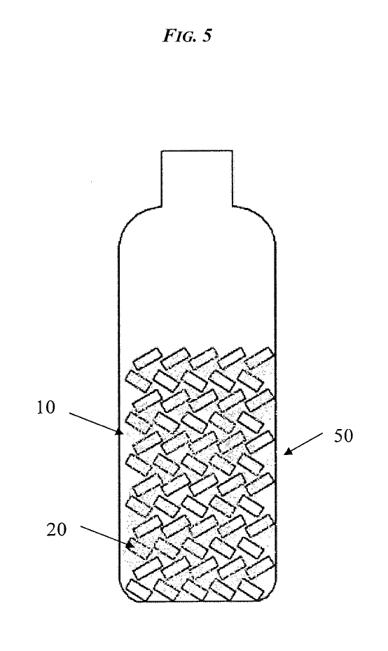

With reference to FIG. 4, an illustration of a bottle holding pulverized plastic resin 30 mixed with phosphor powder 10 is shown as a pulverized plastic and phosphor powder mix 40. An alternative of this is shown in FIG. 5, which is an illustration of a bottle holding plastic resin 20 mixed with phosphor powder 10, which together forms a plastic and phosphor powder mix 50. Both the mixes 40, 50 combine the phosphor powder 10 with a resin. The decision to use the resin in its pellet form or pulverized form can depend, at least in part, on the type of phosphor used and how it interacts with the resin during compounding. Care can be taken to weigh out a precise amount of phosphor powder 10, and again care can be taken to weigh out a precise amount of plastic resin 20 or pulverized plastic resin 30. The two weighed components can be placed in one container together. The container can be chosen as one that the phosphor powder 10 does not attract towards, such as anti-static plastics, galvanized or stainless steels, or glass. If a container is selected that has a high attraction to the phosphor, the phosphor can stick to the side walls of the container and the ratio of phosphor to plastic can undesirably change once the mix is removed from the container. The containers of mixes 40, 50 can be distributed evenly by shaking or tumbling the container for a period of time until a homogeneous mix is achieved. Commercially available tumbling or shaking equipment for small containers or large drums can be utilized. It can be preferable to carry out this mixing process within the same container since removing the mix and placing it in a physical agitator type mixer can increase the risk of introducing contamination or unneeded forces into the mix that in turn can jeopardize the performance of the finished product.

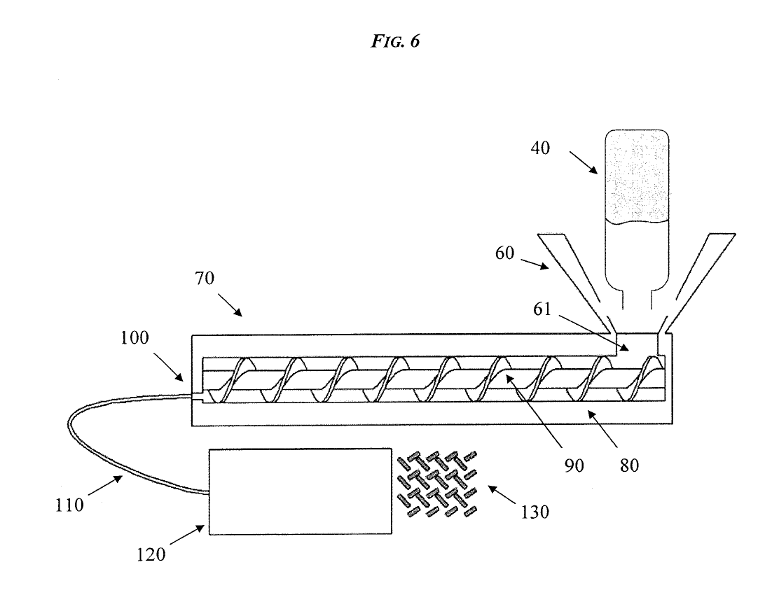

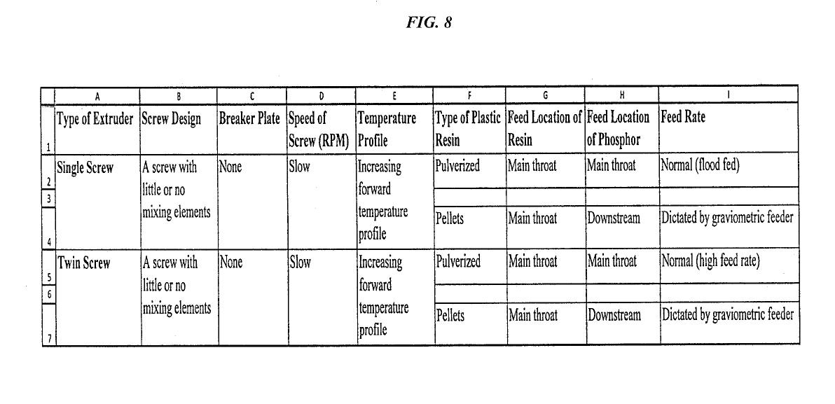

With reference to FIG. 6, a schematic drawing of a plastic extrusion compounding process is shown. The process can generally take the homogeneous mixture 40, 50 described in FIG. 5 and turns it into a plastic kernel or pellet. This process can melt, mix, extrude and pelletize the mixture into the kernels. For this process, a compounding extruder 70 with either single or multiple screws 90 can be used. The extruder (barrel and screw design, barrel and screw material and finishes) and processing conditions (temperature, speed) can be designed so that the process exerts the least amount of possible forces and stress on the phosphor powder 10. Examples of some such processing conditions can be found in FIG. 8, which is described further below.

If inappropriate equipment or processing conditions are selected, the resulting phosphorized plastic pellets can have reduced optical and excitation efficiencies. The discovery of such reduced optical and excitation efficiencies, however, cannot typically occur until the pellet is provided to the manufacturer of the final part or lamp, or by way of a process that may be developed to test phosphorized plastic pellets. In accordance with the present teachings though, reduced optical and excitation efficiencies can be identified at the extrusion compounding phase of the process, for instance, by comparing the color and vibrancy of the plastic pellet to the phosphor or phosphor mix. For example, if there is darkening of the color or discoloration it can be indicative of poor processing conditions of the compounding extruder. These optical and excitation inefficiencies of the inferior phosphorized plastic pellets when formed into the finished product can result in decreased lumens and incorrect chromaticity, CCT and/or CRI.

The process can begin with taking either the pulverized plastic phosphor mix 40 or the plastic and phosphor powder mix 50 and placing the homogeneous mixtures into the hopper 60 of the extruder 70. An alternative method, which is not illustrated, can include taking the phosphor powder 10 and inserting it into the extruder 70 downstream from the feed throat 61 using, for example, gravimetric feeders to weigh out proper ratios of phosphor and plastic resin. Such a method can remove the need for the steps shown in FIG. 4 and FIG. 5. While this method is also possible, it can require more specialized and expensive equipment from the process illustrated in FIG. 6. The extruder 70 can include a heated barrel 80 and single or multiple screws 90. The mixture 40 can enter the feed throat 61 and can be heated by the barrel 80. The mixture 40 can melt while travelling through the extruder 70, for instance, by way of a combination of heat by the barrel 80 and friction from the screw 90 moving the material forward. Eventually the mixture 40 can be completely melted inside the extruder 70. It can reach a die 100, where the material can exit the extruder 70 and can be pulled as one or more strands 110. The strands 110 can be cooled, for instance, by air or water in order to bring it to its room temperature state. The strands 110 can enter a pelletizing machine 120 which can include, for instance, knives that spin in a circular motion in order to chop the strands 110 into pellets or kernels. The phosphorized plastic kernels 130 can be released from the pelletizing machine 120 and can be collected in a container. The kernels 130 have now been mixed on a molecular level so that the phosphor 10 and plastic 20 are substantially, evenly distributed throughout. Although in the present example extrusion processes are performed to create the kernels, in other embodiments other processes can be used, including blow molding, injection molding, and thermo-formation. Some non-limiting examples of processing parameters for two different types of extruders are shown in FIG. 8 and described in further detail below.

In still a further embodiment, the amount of thermal cycling can be reduced by feeding mixed plastic directly into a downstream molding machine to be formed into the final part. The molding machine can be any type of machine, such as machines discussed herein, including sheet, profile, and injection molding machines. This can also lead to improved optical properties of the resulting component by limiting damage to the same.

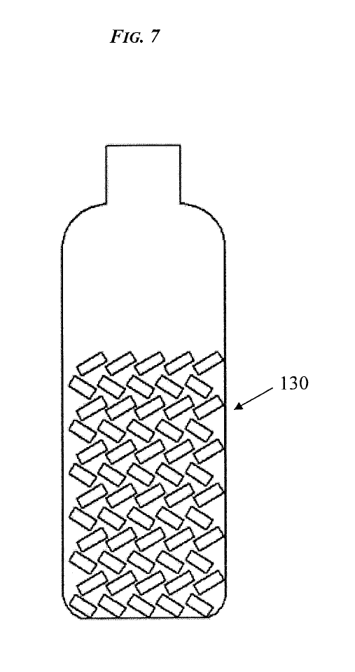

With reference to FIG. 7, an illustration of a bottle holding phosphorized plastic kernels 130 is shown. The kernels 130 can be immediately used or stored for later usage, such as for further processing into finished components. While phosphor powder 10 generally needs to be stored and used in a carefully controlled environment due to its tendency to be static, stick to containers, easily be carried away by air when moved to a new container, and risk of contaminants, the kernels 130 can have a virtually indefinite shelf life, and can easily be washed if they are dropped or left in an open container (where they may collect dust or other contaminants). The phosphorized plastic kernels 130 are stable in their current state and generally pose little to no safety risk when handled. Gloves and respirators that may be required for handling phosphor powder 10 are no longer needed since the dangerous powder is now encapsulated completely into the plastic resin to form the (safe to handle and breathe) phosphorized plastic pellet 130.

FIG. 8 illustrates a chart of some non-limiting examples of processing parameters for two different types of compounding extruders.

Column A describes the type of extruder. Two commonly available extruders include a single screw extruder and a twin screw extruder, which a person skilled in the art would recognize refers to the number of screws in the barrel of the extruder.

Column B describes the screw design. In some embodiments, screws can have conveying, mixing, stretching, kneading, and other elements as part of their design. As shown, in some embodiments both the single and twin screw extruders can have a screw with little or no mixing elements. In some embodiments, a screw that only conveys the material forward, towards the die, can be used. Any mixing elements along the length of the screw can potentially increase the amount of forces put on the phosphor, which can cause inefficiencies in optical transmittance.

Column C indicates whether a breaker plate is present. A person having skill in the art will recognize that a breaker plate is a plate that can go directly before a die and can restrict flow. In the illustrated embodiments, no breaker plate is provided for either the single or twin screw extruders. The breaker plate, if provided, can be a breaker plate with a clear pass through from the barrel to the die. In some embodiments it can be preferable that no features such as a screen pact or holes exist in the breaker plate. In some embodiments using a breaker plate with features can potentially increase the amount of forces put on the phosphor, which can cause inefficiencies in optical transmittance.

Column D describes the speed of screw. As shown, the speed of the screw is described in relative terms, e.g., slow, but more specific speeds can also be indicated, for instance be specifying the number of revolutions per minute (RPM) that the screw turns inside the barrel. In the illustrated embodiments the speed of the screw for both the single and twin extruders can be relatively slow with respect to the speeds the extruder can handle. Operating the screw at higher RPMs can potentially increase the amount of forces put on the phosphor, which can cause inefficiencies in optical transmittance.

Column E describes the temperature profile, which can refer to the temperature settings of the extruder. In some embodiments, extruders can have multiple individual temperature controllers for the barrel and the die. While in some embodiments temperatures for specific controllers can be specified, in the illustrated embodiment the temperature profile for both the single and twin screw extruders indicates that the profile is an increasing forward temperature profile, which can mean that the temperature is highest closest to the main throat feeding section and lowest closest to the die. The high temperature near the main feed throat can allow for a fast melt of the phosphor into the plastic, which can lower the temperature after the melt has occurred, which in turn can reduce the likelihood of forces being put on the phosphor and causing inefficiencies in optical transmittance.

The remaining four columns of the chart can follow the choice of the type of extruder and the type of plastic resin. Column F refers to the type of plastic resin that can be mixed with the phosphor. A number of different resin types can be chosen, including but not limited to a natural pellet form of the resin and a pulverized form in which the resin is pulverized into smaller particles. Both a natural pellet form and a pulverized form are illustrated in the chart of FIG. 8. Column G describes the feed location of the resin. Two options for the feed location of the resin can include at the main feed throat and at a location in the barrel, downstream from the main feed. Column H describes the feed location of the phosphor. Similar to the feed location of the resin, two options for the feed location of the phosphor can include at the main feed throat and at a location in the barrel, downstream from the main feed. Column I describe the feed rate of the material, including the resin and the phosphor going through the extruder, which a person having skill in the art will recognize can describe the rate at which material is introduced into the barrel. While in the illustrated embodiment relative terms are used to describe the feed rate, in other embodiments specific feed rates can be provided, for instance by specifying how much of the material can be fed per minute. In some embodiments an operator can try to keep a concentration level of the phosphor in comparison to the resin constant. By way of non-limiting example, if an operator of an extruder attempts to run it in a slower manner, for instance at a rate of about 10 lb/hr, a feed rate of the phosphor can be dictated by a speed rate of the resin to yield a constant concentration level.

In some embodiments, if the extruder is a single screw extruder and the type of plastic resin is pulverized into fine particles (cell F2), then the resin can be fed into the main throat (cell G2) of the extruder and the phosphor can also be fed into the main throat (cell H2) of the extruder. In this configuration, the phosphor and pulverized resin can be mixed into a homogeneous mixture, as described above, before it is introduced into the main feed throat. The feed rate (cell I2) of the mixture can be a normal feed rate, which for a single screw extruder can mean that the mixture is introduced into the extruder by flood feeding, i.e., simply flooding the main feed throat.

Alternatively, in some embodiments, if the extruder is a single screw extruder and the type of plastic resin is in pellet form (cell F4), then the resin can be fed into the main throat (cell G4) of the extruder and the phosphor can be fed downstream of the extruder (cell H4). In this configuration, the phosphor and pellet resin may not be mixed prior to this extrusion process. A gravimetric feeder, which a person having skill in the art will recognize is a feeder that can convey material based on weight, or a volumetric feeder, which a person having skill in the art will recognize is a feeder that can convey material based on volume, can be used to meter both the plastic resin and the phosphor into the extruder at desired, precise ratios. The feed rates (cell I4) of the plastic resin and phosphors can be controlled by the gravimetric or volumetric feeders and can depend, at least in part, on the ratios desired.

In some other embodiments, if the extruder is a twin screw extruder and the type of plastic resin is pulverized into fine particles (cell F5), then the resin can be fed into the main throat (cell G5) of the extruder and the phosphor can also be fed into the main throat (cell H5) of the extruder. In this configuration, the phosphor and pulverized resin can be mixed into a homogeneous mixture, as described above, before it is introduced into the main feed throat. The feed rate (cell I5) of the mixture can be a normal feed rate, which for a twin screw extruder can actually mean that the mixture is fed at a high feed rate. A person having skill in the art would recognize that twin screw extruders are not required to be flood fed.

Alternatively, in still some other embodiments, if the extruder is a twin screw extruder and the type of plastic resin is in pellet form (cell F7), then the resin can be fed into the main throat (cell G7) of the extruder and the phosphor can be fed downstream of the extruder (cell H7). In this configuration, the phosphor and pellet resin may not be mixed prior to this extrusion process. A gravimetric feeder or a volumetric feeder can be used to meter both the plastic resin and the phosphor into the extruder at desired, precise ratios. The feed rates (cell I7) of the plastic resin and phosphors can be controlled by the gravimetric or volumetric feeders and can depend, at least in part, on the ratios desired.

A person having skill in the art will recognize that the parameters described with respect to the chart in FIG. 8 can be mixed and matched as desired to create desired outcomes, and further, are not limited to the example parameters provided within the chart. Other parameters not identified in a particular column or row of the chart can be incorporated with the teachings herein without departing from the spirit of the invention.

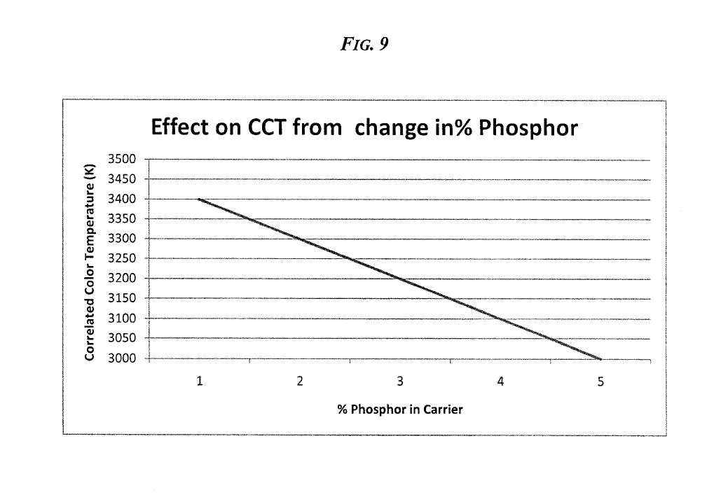

FIG. 9 illustrates a graph of one example relationship between phosphor loaded in a carrier and the resulting correlated color temperature (CCT). On the x-axis, this graph shows a percentage of phosphor, starting at about 2.1% and extending to about 2.5%, while the y-axis illustrates the CCT in Kelvin. As shown, as the percent of phosphor in the carrier increases, the CCT decreases at an approximately linear rate. At the highest percent of phosphor in the carrier illustrated in the example, about 2.5%, the CCT is lowest, at about 3000K, which can be indicative of a transformation to a warmer yellow light. At the lower percentages of phosphor in the carrier, such as the lowest percent of phosphor in the carrier illustrated in the example, about 2.1%, the CCT is highest, about 3400K, which can be indicative of a cooler white light. As phosphor is added to the carrier, the wavelength of the light can be altered so that the product is a warmer yellow light. Thus, to achieve a warmer light, more phosphor can be added, which can decrease a percentage of cooler colors. While in the illustrated embodiment a percentage of phosphor with respect to the carrier is in the range of about 2.1% to about 2.5%, other compositions can be used. For example, in some embodiments, a particular amount of one or more phosphors with respect to a particular amount of the carrier in which the one or more phosphors is disposed can be in the range of about 2% to about 20%.

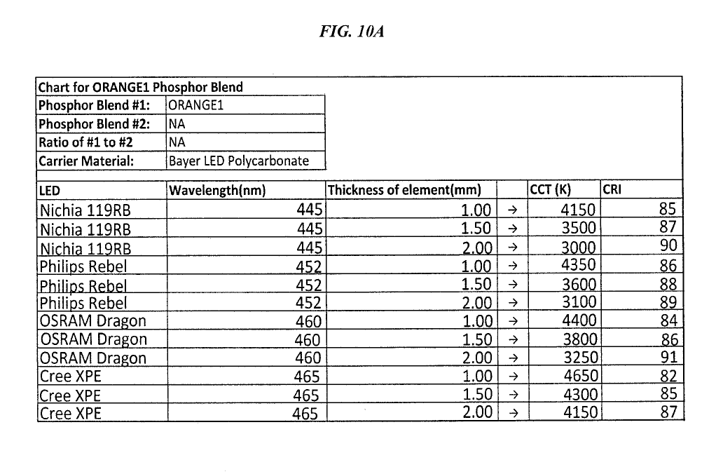

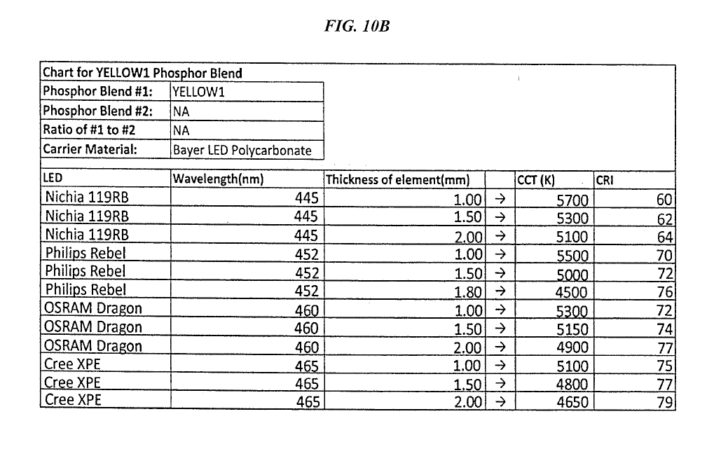

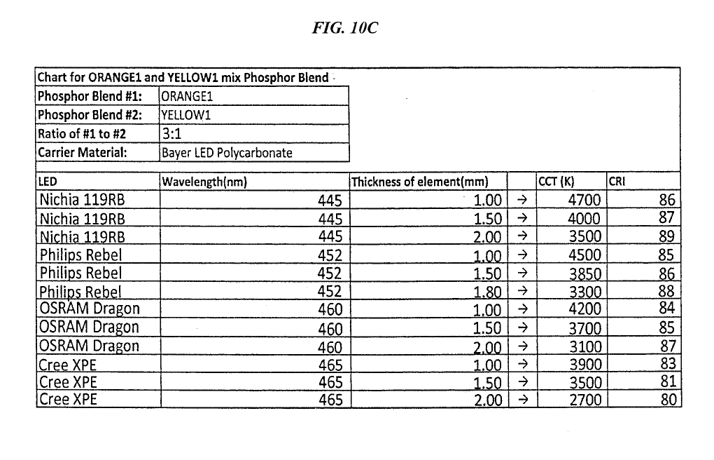

FIGS. 10A-10C illustrate a series of charts representing examples of information manufacturers of finished remote phosphor components that incorporate phosphorized kernels in accordance with the present teachings, such as LEDs, lamps or other products, can use to assist in such manufacturing.

For example, the first column of FIGS. 10A-10C, LED, can provide examples of various types of LEDs to which the present teachings can be applied. The examples shown in FIGS. 10A-10C list some commercially available LEDs, including the Nichia 119RB, the Philips Rebel, the OSRAM Dragon, and the Cree XPE, although other LEDs can also be included. For example, when selling pellets to a customer, a longer list of available pellets can be provided.

The second column of FIGS. 10A-10C, Wavelength (nm), can provide a wavelength of blue light for the LED listed in column A. The wavelength can be constant among specific LEDs, and generally cannot be manipulated.

The third column of FIGS. 10A-10C, thickness of element (mm), can provide examples of various thicknesses a plastic pellet can be molded to form. For instance, in some embodiments a thinner plastic can be more malleable than a thicker plastic, but it can also be less sturdy, while a thicker plastic can be more structurally robust. A person having skill in the art can determine a thickness of the plastic, based, at least in part, on the person's specific needs and/or applications. However, a person having skill in the art will also recognize that different thicknesses of plastics can change the color rendering index (CRI) and correlated color temperature (CCT). Thus, FIG. 10A illustrates in columns 5 and 6 what plastic thicknesses produce which CCTs and CRIs in some embodiments. This streamlined process can enable customers to accurately and quickly determine the thickness of plastic desired to meet the person's needs and/or applications. The arrows in the chart represent how CRIs and CCTs can be contingent on plastic thickness and wavelength.

While FIG. 10B illustrates the same information as FIG. 10A, FIG. 10B represents an example of a different plastic material. Unlike FIG. 10A, which is named ORANGE1 for its composition and color, FIG. 10B has a different composition, and thus, a different name, to wit, YELLOW1. Similarly, FIG. 10C illustrates the same information as FIGS. 10A and 10B, but FIG. 10C represents yet another example of a different plastic material. The name of the plastic material in FIG. 10C is ORANGE1 and YELLOW1 mix, indicating the plastic of FIG. 10C is a mixture of the plastics used in FIGS. 10A and 10B. A person having skill in the art will recognize that many different plastics can be made using different types, colors, and mixtures of phosphor, and that FIGS. 10A-10C are simply examples of how this application can help manufacturers derive preferred CRIs and CCTs.

One having skill in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A composition to assist in formation of light, comprising:
a mixture including:
a particular amount of a carrier selected from the group consisting of: one or more plastic materials, one or more glass materials, and one or more ceramic materials; and
a particular amount of one or more phosphors.

2. The composition of claim 1, wherein the particular amount of the carrier is pulverized.

3. The composition of claim 1, wherein at least one of the one or more phosphors is in powder form.

4. The composition of claim 1, wherein the mixture is homogenous.

5. The composition of claim 1, wherein the composition comprises one or more kernels, each kernel including the mixture.

6. The composition of claim 1, wherein a ratio of the particular amount of the carrier to the particular amount of the one or more phosphors is approximately in the range of about 2% to about 20%.

7. A system to assist in formation of light, comprising:
the composition of claim 1; and
one or more data tables having data related to properties of the composition to inform the particular amount of the carrier and the particular amount of the one or more phosphors to be used in the mixture.

8. The system of claim 7, wherein the data of the one or more tables includes data related to at least one of the following properties: a thickness of a device with which the composition will be used, a wavelength of LED light excitation, and a process by which the mixture is to be formed.

9. The system of claim 8, wherein the process by which the mixture is to be formed comprises extrusion.

10. The system of claim 8, wherein the process by which the mixture is to be formed comprises injection molding.

11. The system of claim 8, wherein the process by which the mixture is to be formed comprises blow molding.

12. The system of claim 7, wherein the data of the one or more tables includes data related to at least one of the following properties: a chromaticity of a resulting kernel, a correlated color temperature (CCT) of a resulting kernel, and a color rendering index (CRI) of a resulting kernel.

13. A method of creating white light, comprising:
positioning the composition of claim 1 proximal to a LED die of a light source; and
securing the composition such that it is substantially fixed.

14. A method of manufacturing a composition to assist in formation of light, comprising:
mixing a carrier and one or more phosphors to form a mixture;
inserting the mixture into an extruding device;
processing and heating the mixture using the extruding device to produce one or more strands of mixture; and
forming kernels from the one or more strands of mixture.

15. The method of claim 14, further comprising pulverizing the carrier prior to mixing the carrier with the one or more phosphors.

16. The method of claim 14, wherein mixing a carrier and one or more phosphors further comprises mixing a particular ratio of carrier to one or more phosphors.

17. The method of claim 16, wherein the ratio is in the range of about 2% to about 20%.

18. A method of manufacturing a LED lamp, comprising:
mixing a carrier and one or more phosphors to form a mixture;
feeding the mixture into a molding machine;
operating the molding machine to form a LED lamp that comprises the mixture.

19. The method of claim 18, wherein mixing a carrier and one or more phosphors further comprises mixing a particular ratio of carrier to one or more phosphors.

20. The method of claim 19, wherein the ratio is in the range of about 2% to about 20%.
